(19) United States
(12) Patent Application Publication
(10) Pub. No.: US 2018/0082304 A1
(43) Pub. Date: Mar. 22, 2018

(54) SYSTEM FOR USER IDENTIFICATION AND AUTHENTICATION

(71) Applicant: PINN Technologies, Redwood City, CA (US)

(72) Inventors: William Christopher Summerlin, Half Moon Bay, CA (US); David Michael Westerhoff, Sunnyvale, CA (US); Timothy Chiheng Co, Foster city, CA (US)

(21) Appl. No.: 15/711,950

(22) Filed: Sep. 21, 2017

Related U.S. Application Data
(60) Provisional application No. 62/397,858, filed on Sep. 21, 2016.
(60) Provisional application No. 62/533,598, filed on Jul. 17, 2017.

(51) Int. Cl. G06Q 20/40; H04L 29/06; H04W 12/06; G06Q 20/10; G06Q 20/32; G06N 3/08; G06N 3/04

(52) U.S. Cl. CPC G06Q 20/40145; H04L 63/083; H04L 63/0861; H04W 12/06; G06Q 20/4012; G06Q 20/325; G06Q 20/3227; G06N 3/08; G06N 3/04; G06Q 20/1085

(57) ABSTRACT

A method includes obtaining identification data indicative of a subject's identity; identifying the subject using a computer system based on the identification data; obtaining, using one or more sensors, a plurality of authentication data each separately indicative of the subject's identity, at least one of the authentication data being obtained passively; individually analyzing each one of the plurality of authentication data using the computer system; and validating or denying the subject's identity, using the computer system, based on the analysis of the authentication data. Systems for authenticating a subject's identity are also disclosed.

### CROSS-REFERENCE TO RELATED APPLICATIONS

This application claims the benefit of priority to U.S. Provisional Applications Ser. Nos. 62/397,858 and 62/533,598, filed on Sep. 21, 2016 and Jul. 17, 2017 respectively. The entire contents of both applications is hereby incorporated by reference.

### BACKGROUND

Fraud is an ongoing concern in many spheres of modern society, including identity theft and other forms of fraud that have significant economic impact. For example, it is estimated that fraudulent transactions at automated telling machines (ATM) cost financial institutions and their insurers as much as $1,000 per machine each year.

Institutions have adopted various techniques for authenticating a person's identity in order to reduce fraud. For example, a common authentication method requires a user to enter a pin number to authenticate their identity when using an ATM card at an ATM. Here, the institution identifies the ATM user based on information stored on the card and verifies the user's identity by matching the pin number input by the user with the information on the card. This is an example of single factor authentication, because a single instance of authentication data, i.e., the pin number, is used to verify the user's identity. However, such techniques are susceptible to fraud where an unauthorized user obtains the card and the pin number (e.g., by guessing a commonly-used sequence of numbers, like 1234, 0000, 2580, which the user has set as their pin).

Moreover, in many instances, institutions do not have an audit trail sufficient to verify or challenge activity that a customer alleges is fraudulent. For instance, in some cases an ATM card holder may fraudulently deny they made a withdrawal at an ATM and the ATM owner does not have an audit trail sufficient to verify the identity of the person who made the withdrawal.

Another example where reliable identity verification may be desirable is where a driver contests a toll booth violation claiming they were not the person driving their car when the violation occurred. Generally, the vehicle can be identified unequivocally by photographing its license plate, but it is impossible to verify who the driver of the car was at the time of the violation absent some additional information attributable to an individual driver.

Multifactor authentication is also used in various settings. For example, private networks (e.g., private corporate or government networks) may require two factor authentication at logon. The first factor is the user's password. The second factor is an authentication code sent by the network administration to the user (e.g., via email or text message) to a contact e-mail address or phone number associated with the user's account. Within an allotted time, the user is required to retrieve the message and enter the authentication code to proceed with the login. While two factor authentication may reduce unauthorized breaches of the network compared with single factor authentication logins, two factor authentication can be inefficient and annoying to the user. Moreover, two factor authentication may be ineffective because it only requires that someone have the user's mobile phone to obtain the authentication code.

### SUMMARY

Systems and methods for multifactor authentication are described. At least some of the data used for authenticating a person's identity is obtained passively. This means that the data is obtained without the user being prompted to separately provide the authentication data. Passively-obtained authentication data may be obtained from activity the user engages in when they interact with a system via a terminal. For example, the authentication data may be obtained from keystroke information obtained when the user inputs their passcode into a computer, mobile device, ATM, point-of-sale device, or other terminal. Authentication data may be obtained from images of the user obtained while the user interacts with the system. Authentication data may be obtained from the user's mobile device or other sensors worn or carried by the user.

Authentication data may relate to physical or behavioral characteristics of a person. Physical characteristics include facial features and other bioinformatic markers such as fingerprints or iris information. Behavioral characteristics include characteristics of how a user interacts with an interface, such as keystroke characteristics and touch panel characteristics. Behavioral characteristics also include characteristics of how a person moves, such as their gait.

In some implementations, the system provides continued authentication during the time that the user is engaged with the system. For example, while the user is logged in to a server in an extended engagement, the system can obtain new authentication data continuously or periodically and use the data to provide updated authentication of the user's identity over the course of the session. For example, during an ongoing session, the system can continue to monitor keyboard stroke information, mouse motion information, touch panel input information, and/or other information having attributes that can be used to authenticate the user. Where the new authentication data continues to verify the identity of the user, the session can continue without interruption. Data that no longer passes the authentication threshold can trigger a different response, such as a request for additional authentication data from the user, termination of the session, and/or flagging the session for the system's administrator. Ongoing identity verification can be useful in mitigating fraudulent activity in situations where a user forgets to logout of a session, for example.

In some implementations, the user has accounts with a variety of primary entities, e.g., financial institutions, retailers, etc. However, the user's authentication data may be associated with a unique global identity maintained by a trusted third party entity. In addition, that data may be verifiable only by the trusted third party entity, and not by the primary entities. In such instance, only this single trusted third party is able to authenticate the user's identity for the primary entities.

In some implementations, a SIM card of a mobile device provides a user authentication applet that performs authentication of the identity of the user of the mobile device. The authentication of user identity can be used to grant access to a secure network.

In some implementations, user authentication is used to establish control over Internet-of-Things (IoT) connected devices, and set ownership of the IoT devices.

In some implementations, multiple authentication servers are provided to provide redundancy and protection against authentication server breaches.

In general, in a first aspect, the invention features a method that includes obtaining identification data indicative of a subject's identity; identifying the subject using a computer system based on the identification data; obtaining, using one or more sensors, a plurality of authentication data each separately indicative of the subject's identity, at least one of the authentication data being obtained passively; individually analyzing each one of the plurality of authentication data using the computer system; and validating or denying, using the computer system, the subject's identity based on the analysis of the authentication data.

Implementations of the method can include one or more of the following features. For example, analyzing the user's identity can include scoring each of the authentication data to provide a score, each score being indicative of a level of confidence of the subject's identity based on the corresponding authentication data. Scoring can include using a corresponding predictive computer model to analyze authentication data. The authentication data can include information about one or more attributes of the subject that are input into the predictive computer model. The predictive computer model can include an algorithm selected from the group consisting of: an artificial neural network algorithms, a regression algorithm, an instance-based algorithm, a decision tree algorithms, a Bayesian algorithms, a clustering algorithm, a deep learning model, and an ensemble algorithms.

Validating or denying the subject's identity comprises calculating a combined score based on the score for each of the authentication data. Calculating the combined score can include weighting each of the scores based on information about a quality of the corresponding authentication data. The scores can be weighted based on static weights for one or more of the authentication data. The scores can be weighted based on dynamic weights for one or more of the authentication data. The information about the quality of the corresponding authentication data can be obtained with the authentication data.

The identification data can be obtained actively or passively. The identification data can be obtained actively via interaction of the subject with a user interface (e.g., a mobile device, and an automated telling machine (ATM), a personal computer). The identification data can be obtained passively based on a wireless data transfer from a mobile device or based on an image of the subject or an image of a possession of the subject's. For example, identification data may be based on an image of the user's car (from which identifying information such as make, model, color, license plate, etc. may be gleaned).

The identification data can include information about a vehicle associated with the subject.

Each of the authentication data can include data for analysis by a corresponding identification module. The identification modules can include at least one human identification module. The human identification modules can be selected from the group consisting of: a facial recognition module, a voice recognition module, a keystroke module, a language analysis module, a heartbeat module, a gait module, a device motion module, a driving behavior module, a fingerprint module, an iris module, a 3D facial recognition module, a foot shape/pressure module, an ear biometric module, an operator signature module, and a thermal signature module.

The identification modules can include at least one object identification module. For example, the object identification module can be selected from the group consisting of: a device fingerprint module, a network forensics module, a fixed LPR module, a cascade LPR module, an NFC module, a fixed low energy wireless module, a cascade low energy wireless module, a thermal signature module, and an audio signature module.

Analyzing the authentication data can include accessing a physical model of the subject and comparing the authentication data to corresponding portions of the physical model. The physical model can include a model selected from the group consisting of: a model of the subject's facial features, a model of the subject's physical proportions, a model of the subject's fingerprint, a model of the subject's iris, and a model of the subject's thermal signature.

Analyzing the authentication data can include accessing a behavioral model of the subject and comparing the authentication data to corresponding portions of the behavioral model. The behavioral model can include a model selected from the group consisting of: a model of the subject's keystroke attributes, a model of the subject's written language attributes, a model of the subject's spoken language attributes, a model of the subject's gait, and a model of the subject's driving attributes.

In general, in a further aspect, the invention features a system for authenticating a subject's identity that includes a network access point comprising a user interface configured to receive identification data indicative of the subject's identity and to obtain a plurality of authentication data each separately indicative of the subject's identity, at least one of the authentication data being obtained passively; and an authentication server in communication with the network access point, the authentication server being configured to receive the authentication data, individually analyze each of the authentication data, and validate or deny the subject's identity based on the analysis of the authentication data.

Embodiments of the system can include one or more of the following features and/or may be configured to perform the methods of the first aspect discussed above.

The user interface can include a keypad and the authentication data comprises data received from the keypad. The user interface can also include a headset. The network access point can include a camera and the authentication data comprises data received from the camera. The network access point can include components for wireless communication (e.g., a Wi-Fi, Bluetooth, or NFC chipset) with a wireless device (e.g., a mobile phone or a smartwatch).

The network access point can be an automated telling machine (ATM), a networked personal computer, or a wireless device. In some embodiments, the network access point is a point-of-sale terminal.

The system can include an institution server in communication with the terminal and the authentication server, where institution server storing profile data related to a profile of the subject.

The terminal and authentication server may be in communication via a wide area network, such as the internet.

The authentication server may be configured to receive authentication data from one or more additional sources in addition to the network access point, such as from a wireless data network.

Among other advantages, implementations of the technology may reduce fraudulent activity. The technology may be used to generate an audit trail for investigating alleged fraud. The technology may be used to secure confidential information. The technology may be used to alleviate friction in transactions. The technology may also be used to provide a more contextual experience tailored to the authenticated user. The technology may allow the user to establish a unique global identity with a single trusted party for authentication, limiting the number of parties with access to the user's authentication data.

The details of one or more implementations of the subject matter of this disclosure are set forth in the accompanying drawings and the description below. Other features, aspects, and advantages of the subject matter will become apparent from the description, the drawings, and the claims.

### DESCRIPTION OF DRAWINGS

FIG. 1 is a schematic diagram of an embodiment of a system for passively verifying a person's identity.

FIG. 2 is a flowchart showing steps in the operation of the system shown in FIG. 1.

FIG. 3 is a schematic diagram of another embodiment of a system for passively verifying a person's identity.

FIG. 4 is a schematic diagram of a further embodiment of a system for passively verifying a person's identity.

FIG. 5 is a schematic diagram of an embodiment of a system for authenticating a user to a secure network.

FIG. 6 is a block diagram of an embodiment of a SIM card for authenticating a user to a secure network.

FIG. 7 is a block diagram of an embodiment of a secure network for internet-of-things devices.

FIG. 8 is a schematic diagram of an embodiment of a system for authenticating a user to a secure network using a headset.

FIG. 9 is a schematic diagram of an embodiment of a system for passively verifying a person's identity using multiple authentication servers.

FIG. 10 is a schematic diagram of an example computer system.

Like reference numbers and designations in the various drawings indicate like elements.

### DETAILED DESCRIPTION

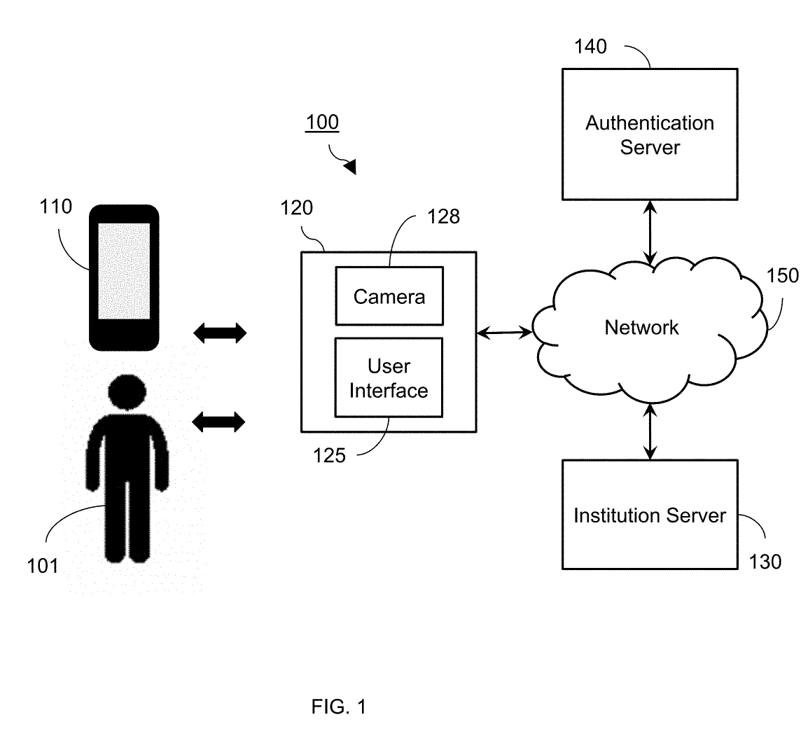

Referring to FIG. 1, an identification/authentication system 100 includes a terminal 120, such as an automated telling machine (ATM), an institution server 130, and an authentication server 140, which communicate with each other over a network 150, such as the internet. Terminal 120 includes a user interface 125, which includes a display and keypad and/or touch panel. Terminal 120 also includes a camera 128 for capturing digital images of ATM users.

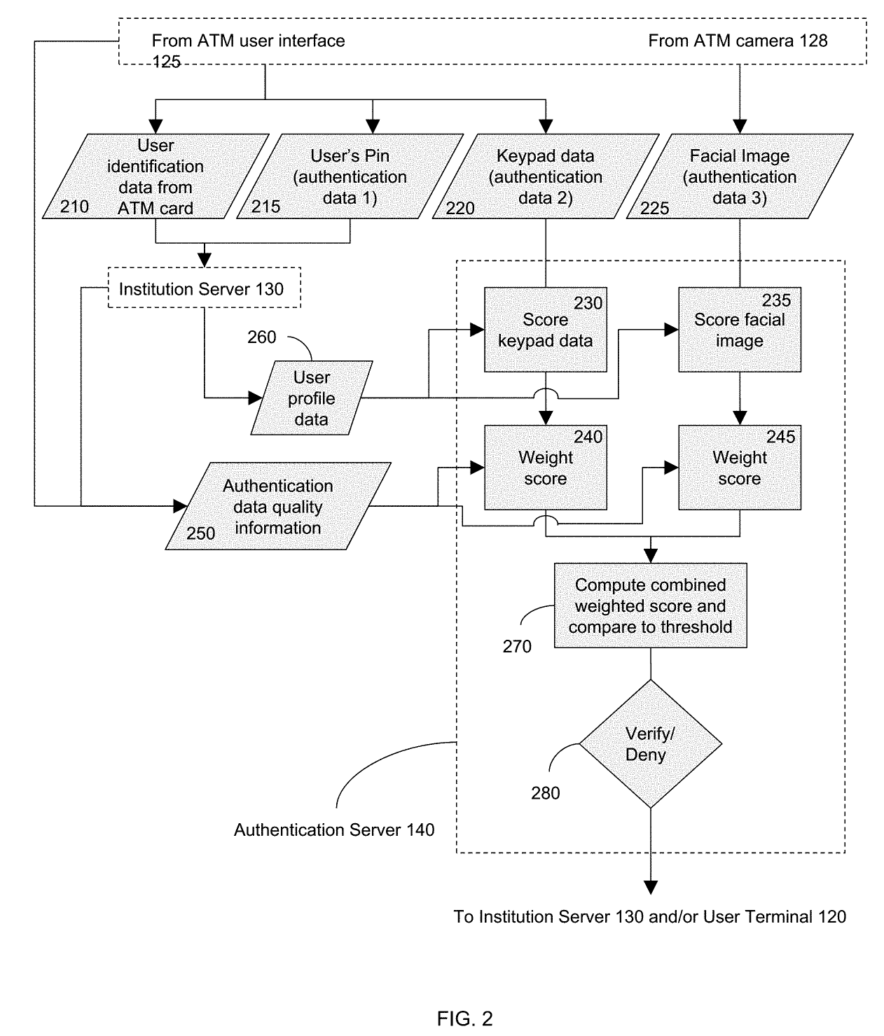

Referring also to FIG. 2, a user 101 interacts with terminal 120 by inserting their ATM card and entering their pin into the keypad, providing user identification data 210 (via the ATM card) and authentication data 215 (via the pin) to system 100. Contemporaneously to user 101 entering their pin, system 100 gathers additional authentication data passively from user 101, allowing the system to verify the user's identity with greater confidence than the single factor authentication provided by the pin.

Specifically, in the present embodiment, system 100 gathers keypad data 220 while user 101 enters his or her pin via user interface 125, and captures a facial image 225 of user 101 at the same time. Keypad data 220 includes information about several attributes characterizing how user 101 input his or her pin into the keypad of user interface 125. Depending on the sensors associated with the keypad, these attributes may include, for each keystroke, dwell time, touch force, position within the button, shape of ellipse at finger/keypad interface, rotation of the ellipse while submitting a keystroke/touch input, as well as interkey latency and other measurable parameters characterizing how the user entered their pin.

System 100 obtains the secondary authentication data passively from terminal 120. In other words, the secondary authentication data is gathered by the system without any additional directed action by the user specifically to provide secondary authentication data. In contrast, obtaining the pin number from the user is considered actively-obtained data, rather than passively-obtained, because terminal 120 specifically prompts the user to input the pin.

System 100 sends user identification data 210 and the user's pin 215 to institution server via network 150. Institution server 130 identifies user 101 based on identification data 210 and pin 215 and, in response to receiving this information, retrieves user profile data 260 from the institution's user database and sends this data to authentication server 140. Profile data 260 includes data relating attributes of user 101 to the keystroke attributes included in keypad data 220 and facial attributes included in facial image 225. In some embodiments, profile data 260 is retained on authentication server 140 in addition, or alternatively, to institution server 130. In such instances, it is sufficient for institution server to send just user identification information to authentication server 140.

At the same time system 100 sends identification data 210 and pin 215 to institution server 130, system 100 sends keypad data 220 and facial image 225 to authentication server 140 via network 150. Authentication server 140 includes modules 230 and 235 for processing each of the authentication data, scoring the authentication data against corresponding user profile data.

In general, scoring modules 230 and 235 can utilize a variety of technologies suitable for the specific task at hand. For example, various machine learning technologies can be applied to score either keypad data 220 and/or facial image 225. These can include artificial neural network algorithms (e.g., perceptron, back-propagation, hopfield network, radial basis function network), regression algorithms (e.g., ordinary least squares regression, linear regression, stepwise regression, logistic regression, locally estimated scatterplot smoothing, and multivariate adaptive regression splines), instance-based algorithms (e.g., k-nearest neighbor, learning vector quantization, self-organizing map, locally weighted learning), decision tree algorithms (e.g., classification and regression tree, conditional decision trees, decision stump), Bayesian algorithms (e.g., Naive Bayes, Gaussian Naive Bayes, Multinomial Naive Bayes, Averaged One-dependence estimators, Bayesian Belief Network, Bayesian Network), clustering algorithms (e.g., k-means, k-medians, expectation maximization, hierarchical clustering), deep learning models (e.g., deep boltzmann machine, deep belief networks, convolutional neural network, stacked auto-encoders), and ensemble algorithms (e.g., random forest, boosting, bootstrapped aggregation, adaboost, stacked generalization, gradient boosting machines, gradient boosted regression trees). In some implementations, least squared anomaly detection is used, such as the technique described by Quinn and Sugiyama in “A least-squares approach to anomaly detection in static and sequential data,” Pattern Recognition Letters, 40, pp. 36-40 (2014).

Scoring modules 230 and 235 may include proprietary, commercially-available, or freely-available software and/or hardware components. For example, module 230 for scoring keypad data may include software from BehavioSec (https://www.behaviosec.com), KeyTrac (https://www.keytrac.net), and/or Watchful Software (https://www.watchfulsoftware.com/en/solutions/keystroke-dynamics).

Module 235 for performing facial recognition can be developed from readily available components, such as FaceNet from Google, for example. FaceNet directly learns a mapping from face images to a compact Euclidean space where distances directly correspond to a measure of face similarity. Once this space has been produced, tasks such as face recognition, verification and clustering can be easily implemented using standard techniques with FaceNet embeddings as feature vectors. See, e.g., Schroff et al., “FaceNet: A Unified Embedding for Face Recognition and Clustering,” Proceedings of the IEEE Computer Society Conference on Computer Vision and Pattern Recognition 2015. The module can process the image of the user's face using the FaceNet system to determine an embedding for the facial image. The system can then access a known embedding for the user and compare the distance between the current embedding and the known embedding, e.g., using an L2 distance, to determine the confidence score. That is, the closer the distance between the current embedding and the known embedding, the higher the confidence.

Other examples of publicly-available facial recognition software that may be used includes software from OpenBiometrics (http://openbiometrics.org), OpenFace(https://cmusatyalab.github.io/openface), Cognitiec (http://www.cognitec.com), MorphoTrust (http://www.morphotrust.com), Ayonix (http://ayonix.com), FaceFirst (http://www.facefirst.com), Luxand (http://www.luxand.com), and Microsoft Cognitive Services (https://www.microsoft.com/cognitive-services).

In some cases, the scoring modules can be adapted to process fragmented data. For example, a keystroke dynamics module may be programmed to account for fragmentation of an expected pin sequence, such as whether the user inputs an incorrect digit, deletes the incorrect digit, and inputs the remainder of the sequence. In such instances, the module may be programmed to detect the deletion, and run the algorithm on the first fragment (before the typo) and the second fragment (after the typo) and disregards the intervening keystrokes where incorrect key was pressed and then deleted.

In some cases, the system can evaluate the quality of the authentication data before scoring it and, in the event that the data is of insufficient quality, acquire additional data for scoring instead. For instance, the system can analyze facial images for quality before scoring the image. This may be done, for example, by ensuring certain attributes of the user are identifiable in an image before scoring the image (e.g., eyes and mouth). If the facial image is of insufficient quality, another facial image can be acquired. Pre-scoring evaluation of data may be performed at terminal 120, at authentication server 140, or elsewhere.

In some embodiments, multiple modules can be used to score the same authentication data. For example, server 140 may include more than one module for scoring a facial image, where the different modules are known to perform better under different circumstances (e.g., one performs better with daylight and the other better when artificial lighting is used).

Scoring modules 230 and 235 output a score signifying a confidence level that user 101's actual identity is what user identification data 210 purports it to be. Typically, the score is a numeric score, such as a percentage.

Next, authentication server 140 separately weights each score (240, 245) based on authentication data quality information 250, which is provided to authentication server 140 by the ATM and/or by institution server 130. Authentication data quality information 250 contains data related to reliability of the authentication data, which can vary depending on a variety of factors, such as, e.g., systemic factors related to the user interface and/or other sensors used to acquire the authentication data, and environmental factors. An example of a systemic factor related to the user interface is the operability of the keypad, which may become damaged, lessening the reliability of the keypad data score. Physical keys on the keypad can become unreliable, requiring more force than other keys or multiple presses to activate. In such circumstances, authentication data quality information 250 can include information that causes server 140 to weight 240 the keypad data score lower than the facial image score.

An example of a systemic factor related to a different sensor are factors relating to the reliability of camera 128. Dirt or other objects can obscure the camera optics, for example, reducing the quality of obtained images. Other factors include possible misalignment of the camera due to impacts, and/or failure of sensor pixels over time. In each case, these factors may worsen the reliability of the score provided by facial recognition module. Accordingly, in such instances, facial image score 235 may be weighted less than keypad data score 230.

In some implementations, authentication data quality information can be obtained by server 140 by monitoring the historic performance of the scoring modules. For example, where one module consistently returns high scores where user identities are verified (e.g., 95% or higher), but after some period of time returns scores in a lower range (e.g., no higher than 60%), server 140 can attribute this to a drop in the systematic reliability of the data and modify the weighting appropriately. In some cases, where systemic changes are noted, the system can report these changes to a system administrator so the corresponding sensor can be investigated.

An example of an environmental factors that may influence the reliability of authentication data includes the light quality around camera 128. Quality of images taken at night, for example, may be of substantially lesser quality than those taken during the day. If artificial lighting is used, image quality may degrade if a light source breaks. Accordingly, authentication data quality information 250 may include data relating to the lighting conditions when the facial image was taken. This may be in the form of a light meter reading, or may simply involve determining from a timestamp whether the image was taken during the day or at nighttime.

Score weighting can also be applied based on the amount of data provided to each authentication module. For example, the system may score multiple different images of the same user, while only a single set of keystroke data is obtained. Accordingly, the facial recognition scores may be more heavily weighted than the keypad data score.

Additionally, one authentication module may be able to more accurately generate confidence scores based on a small amount of baseline data than another. For example, the facial recognition module may be able to generate a reliable score from only a few images of the user's face while the keypad data module may require several baseline keystroke inputs before being able to generate an accurate score. Thus, until a threshold amount of baseline keystroke input data has been obtained, the facial recognition scores may be more heavily weighted than the keypad data score.

In general, weighting can be applied dynamically or statically. Dynamic weighting occurs where the system modifies the weight applied to each score over time to account for, e.g., changes in the quality of authentication data collected from transaction to transaction, or over time generally. Static scoring, where the same weighting is applied to the scores for each transaction, can be used where an authentication technology implemented by a specific module is consistently more reliable than other modules. For example, where the facial recognition technology used is known to be more reliable that the keystroke detection, the facial image score may be more heavily weighted than the keypad data score.

In some embodiments, camera 128 acquires video footage of a user for authentication in addition to still pictures for facial recognition. Video footage may be analyzed for characteristics of the user's motion, such as the user's gait. Accordingly, server 140 may include an additional module for scoring video footage, along with modules 230 and 235.

More generally, authentication data quality information can be provided from other sources as well. For example, authentication data quality information can be stored on authentication server 140. Alternatively, or additionally, the quality information can be transmitted with keypad data 220 and/or facial image 225.

Server 140 then computes a composite score from weighted scores 240 and 245 using a weighted sum rule. Alternatively, the scores can be fused using other rules, such as, e.g., a simple sum rule, an arithmetic mean rule, or can involve a more complex mathematical calculation such as a trained fusion rule. Examples of other rules that may be used are described by Dey and Samanta in “Unimodal and Multimodal Biometric Data Indexing,” published by Walter de Gruyter, Inc. (2014).

More generally, while the example above involves fusing scores at the match score level, other approaches are also possible. For instance, authentication modules can fuse scores at the feature level where the different authentication data are compatible. Alternatively, or additionally, scores can be fused after scoring, e.g., at the decision level. See, e.g., A. Ross and A. K. Jain, “MULTIMODAL BIOMETRICS: AN OVERVIEW,” Proc. of 12th European Signal Processing Conference (EUSIPCO), (Vienna, Austria), pp. 1221-1224, September 2004.

Server 140 compares the composite score to a threshold in order to determine whether to verify or deny (280) user 101's identity. The results of the authentication process are returned, via network 150, to institution server 130 and/or user terminal 120. If user 101's identity is verified, terminal 120 allows user 101 to proceed with the transaction. If the user's identity is denied, terminal 120 terminates the transaction.

While the foregoing example uses keystroke analysis and facial recognition as authentication data, more generally other forms of authentication data may be used in addition or alternative to those described above. In general, any number of authentication data types may be used. In some embodiments, authentication data can be obtained from devices associated with and unique to user 101. Authentication data can be obtained from user 101's mobile phone 110, for example, using wireless data transmission (e.g., low energy Bluetooth, Wi-Fi, RF, or NFC signals). In some cases, this authentication data can be in the form of a digital signature stored in an app on mobile phone 110.

Alternatively, or additionally, other sensors on the mobile phone can be used to collect authentication data for transferring to terminal 120. For example, using an accelerometer, mobile phone 110 can monitor attributes of the user's motion, such as characteristics of their gait, which can be used to verify the user's identity.

Other user personal devices can also be used, such as, for example, wearable devices such as smartwatches or headsets (e.g., google glass).

In some implementations, mobile phone 110 (or other personal device) communicates user identification data to terminal 120 in addition (or alternatively) to authentication data. For example, mobile phone 110 can wirelessly transmit identification data to terminal 120 when the user approaches the ATM. In some implementations, data from mobile phone 110 is used instead of having user 101 scan his or her ATM card at user interface 125. In certain implementations, mobile phone 110 transmits identification data to terminal 125 passively, e.g., without requiring the user to activate a specific application or even take the phone out of their pocket or bag. Alternatively, active transmission may be used, e.g., having user 101 present mobile phone 110 in range of an NFC receiver after having launched an appropriate application for the NFC communication.

Device fingerprinting can be used to identify and validate mobile phone 110.

In many implementations, user 101 sets up a user profile before he or she begins using system 100. The user profile includes information about user attributes required for matching user authentication data to the user. This may include photographs of the user, audio samples of the user's voice, gait data, training data for keystroke dynamics, and so on.

The user profile can be established based on information associated with profiles of the user from other databases. For example, user profile setup can include information from the user's social media accounts (e.g., the user's Facebook profile or LinkedIn profile). In some cases, official government databases (e.g., passport information or driver's license information) can be used to populate the user profile.

While FIG. 1 depicts only a single ATM and a single user, in general, systems will include multiple terminals, each accessible by numerous users. Accordingly, in general, authentication server 140 includes modules corresponding to each authentication data type and the same server is capable of authenticating user identities from a variety of terminals, each having one or more of a variety of different user interfaces and sensors. Some modules for processing authentication data will account for differences between user interfaces on different terminals. For instance, where keystrokes from the same user differ depending on differences in touchpad size from terminal to terminal, authentication data from a terminal should include data allowing the authentication server to make appropriate adjustments in how the data is analyzed by a module. Alternatively, or additionally, the authentication server may route authentication data to different analysis modules entirely, depending on the terminal used.

On the other hand, some modules are agnostic as to user interface. For example, facial recognition module may work equally well on any sufficiently resolved image of the user, regardless of what type of camera was used to capture the image.

In general, the identification/authentication technology described above may be used in a variety of different environments beyond ATM transactions. Moreover, the type of passively-obtained authentication data will depend on the environment in which the technology is used. For example, many commercially-available ATM machines include a keypad or touch panel as part of the user interface, so authentication data retrievable from the user's interaction with the keypad or touch panel are logical options. Facial recognition is a further example that is suitable for ATM's which include a networked camera.

Moreover, other passive identification schemes are also possible, such as facial recognition. For example, in environments in which there are a controlled number of unique users (e.g., 100's or 1,000's of users), passive identification of a user can be reliably performed in a computationally-economic manner. Such environments include, for example, cruise ships and corporate or government buildings where access is controlled. Another example is at an airport gate, where passengers have already checked-in to their flight so the number of verifiable persons is relatively small.

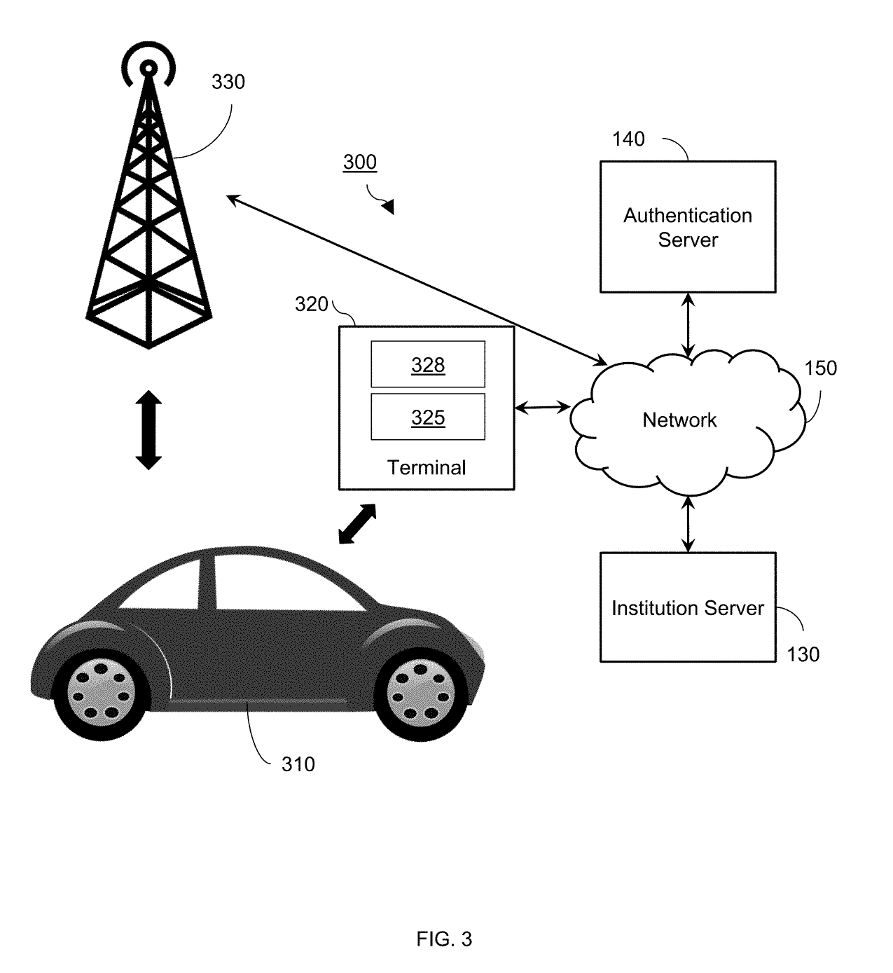

In some implementations, identification/authentication technology is used in car-based transactions, such as retail transactions made at drive thru locations. For example, referring to FIG. 3, a system 300 for user authentication in car-based transactions includes a terminal 320 which facilitates a transaction with a user inside a car 310. In the case of a drive thru restaurant, for example, the terminal includes the microphone and speaker 325 at which the user places their order. Terminal 320 also includes a camera 328, arranged to acquire an image of a car's license plate while the car's driver places an order using the microphone and speaker. Terminal 320 is in communication with institution server via network 150, as well as with authentication server 140. System 300 also includes a wireless data network such as a mobile telephone network, which is depicted here by antenna 330, which communicates with terminal 320, institution server 130 and authentication server 140 via network 150. Car 310 includes appropriate RF transmitters and receivers enabling the car to communication with antenna 330. System 300 facilitates the drive thru transaction by passively identifying and verifying the driver, and charging the driver's account without any directed payment action by the driver as follows.

As car 310 approaches terminal 320, camera 328 takes an image of the car's license plate and transmits this information via network 150 to institution server 130 as user identification data. Institution server 150 performs analysis of the license plate, reading the license plate number and identifying the driver on the basis of their license plate. System 300 transmits the driver's identity to authentication server 140.

Once at terminal 320, the driver places an order to a restaurant worker using the microphone and speaker 325. As the driver speaks, terminal 320 records the audio feed and transmits this information as authentication data to authentication server 140. A module on authentication server 140 performs speech recognition on the audio signal, scoring the signal according to how closely it matches user profile data from institution server 130.

Simultaneously, telematics systems aboard car 310 transmit authentication data to authentication server via antenna 330. This data can include information about how the car is configured (e.g., the seat and mirror positions) that may be matched to an individual driver and/or information about how the car has been driven on the current trip (e.g., how the car accelerates and breaks while driving, route information, etc.). Using one or more appropriate scoring modules, server 140 scores this data according to how closely it matches user profile data from institution server 130.

As described above, authentication server weights the scores from different modules and calculates and combined weighted score which is used to verify or deny the driver's identity, returning the result to terminal 320.

Alternatively, or additionally, antenna 330 communicates with the driver's mobile phone, identifying and/or authenticating the user based on signals from their mobile phone.

When authentication server 140 verifies the driver's identity, the driver's account is charged using account information previously provided.

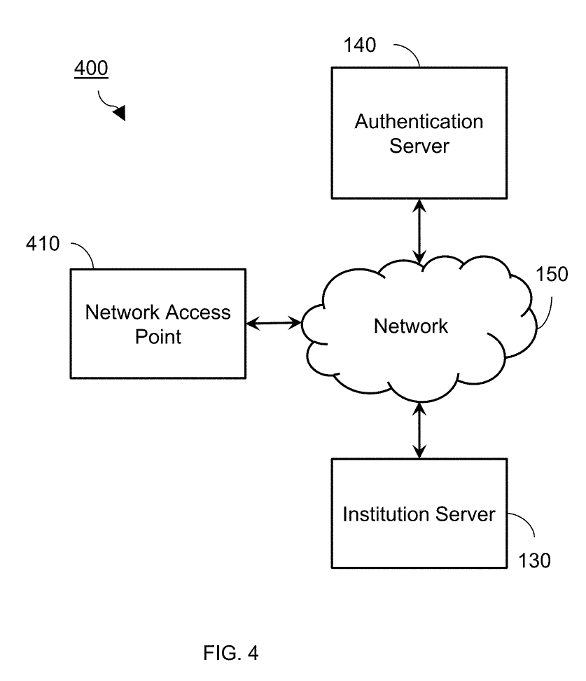

Identification/authentication technology may also be used in online environments. For example, referring to FIG. 4, a system includes a network access point 410, such as networked computer (desktop or laptop) or a mobile device. Network access point 410 includes a user interface 420 featuring one or more peripherals with which the user can engage the system (e.g., keyboard, monitor, mouse, touch panel, webcam, and/or microphone). Access point 410 is in communication (e.g., wirelessly or hardwired or both) with institution server 130 and authentication server 140 via network 150 (e.g., the internet).

Using network access point 410, a user logs into an online environment, for example through a mobile app, requiring identity authentication. Exemplary environments include retail websites and other environments where commercial transactions take place, financial institution websites where a user can view accounts and engage in financial transactions, government agency websites where the user can engage in civil transactions such as updating government records or paying registration fees or taxes. Other online environments where user authentication may be beneficial are commercial or government networks containing confidential or classified information.

During a logon process, system 400 prompts the user for user identification data, e.g., a username, and active authentication data, e.g., a password. At the same time, system 400 passively gathers one or more additional authentication data at network access point. This authentication data can include keystroke data (e.g., from the keyboard or touch panel), mouse motion data, facial images (e.g., from a webcam), voice recognition (e.g., from a microphone). This data is transmitted to authentication server 140 where it is processed to verify or deny the user's identity as discussed previously.

In some implementations, the online environment for logon is provided by a primary entity, e.g., a financial institution, retailer, etc., where the user has an account. If the user's authentication data is associated with a unique global identity maintained by a trusted third party entity, logon authentication may be performed as part of an original authentication flow of a primary entity online logon environment, or the user may be redirected to a third party native environment for an authentication protocol. In some instances, authentication data is verifiable only by the trusted third party entity, and not by the primary entities.

In some implementations, user authentication is performed at more than one time. For example, authentication can be performed once at logon, and then one or more times during an online session. Ongoing authentication may be useful where a user remains logged on to an account over an extended period of time (e.g., several hours or days). Such a situation may arise, for example, where a person remains logged on to a network from a computer in their office over several workdays.

Without requiring separate logins, the system may passively authenticate the user's identity after a pause in activity on the computer, for example. Ongoing authentication may occur after a specific event (e.g., a pause in activity), periodically (e.g., each hour or at the same time each day), or continuously (e.g., authentication data is continuously sent to authentication server while the user is active).

In general, a variety of different user interfaces and sensors can be used to passively gather authentication data. User interfaces and sensors include cameras and other sensors that gather images (still and video), microphones and other sensors for gathering audio data (e.g., speech data, automobile noise), IR cameras and other thermal image sensors, accelerometers, computer mouse (e.g., for gathering data on scrolling, moving, clicking), trackpads (e.g., scrolling and swiping), keyboards, keypads, touchscreens, vehicle data sensors (e.g., for providing vehicle configuration data including seat and mirror positioning, and driving data such as route and velocity data, breaking and acceleration characteristics).

Accordingly, a variety of authentication modules can be used depending on the user interface, sensors available, and specifics of the application such as whether the user interface is for a person or a device (e.g., a mobile phone or a car). For example, various combinations of the authentication modules described above as well as other modules may be used, including a facial recognition module (e.g., 2D image facial recognition, 3D image facial recognition), a hand geometry module, a keystroke dynamics module, a speech recognition module, a mouse motion module, a video analysis module (e.g., for gait detection), an audio analysis module (e.g., voice recognition modules, both text dependent and text independent modules), an accelerometer data analysis module (e.g., for gait detection), a language analysis module, a heartbeat module, a driving behavior module, a fingerprint module, an iris module, a foot shape/pressure module, an ear biometric module, an operator signature module, a thermal signature module, a device fingerprint module (e.g., for mobile devices, cars, computers, etc.; see, e.g., https://audiofingerprint.openwpm.com), a network forensics module, a license plate recognition (LPR) module (e.g., fixed or cascade), a driving behavior module, an audio signature module (e.g., for detecting the audio signature of a car), an NFC module, a fixed low energy wireless module, and a cascade low energy wireless module.

The threshold for user verification may be variably set by, e.g., a system administrator depending on the level of security desired.

Furthermore, while several specific use cases are described, in general, the technology described herein may be applied to a variety of other use cases, including use in enterprises, retail environments, online environments, car-based transactions, airports, and environments where access is restricted, such as corporate or government facilities.

Moreover, while each of the foregoing examples use a separate institution server and authentication server, more generally the processing and database functions can be spread over any number of servers. In some implementations, both identification and authentication are performed using the same server.

In each of the above examples, the system verifies the user's identity at the time of the user's interaction with the system. However, later verification is also possible. For example, in some embodiments, the system simply stores authentication data at the time of the interaction and only processes the data to verify user identity at some later time if needed. For instance, post-interaction verification may be useful where the system is used to generate an audit trail for an institution, rather than real time verification. This may involve storing the authentication data along with other details of a specific transaction and verifying user identity using the data only if identity is later challenged. An example of this is a fraudulent card-based transaction, either online or in person, where the cardholder's pin or password is stolen along with the card. With passively-obtained authentication data, an institution can confirm that the transaction was, in fact, fraudulent by having an authentication server deny the user's identity. In general, user authentication data can be used for either real-time authentication or storing for later auditing purposes, or both.

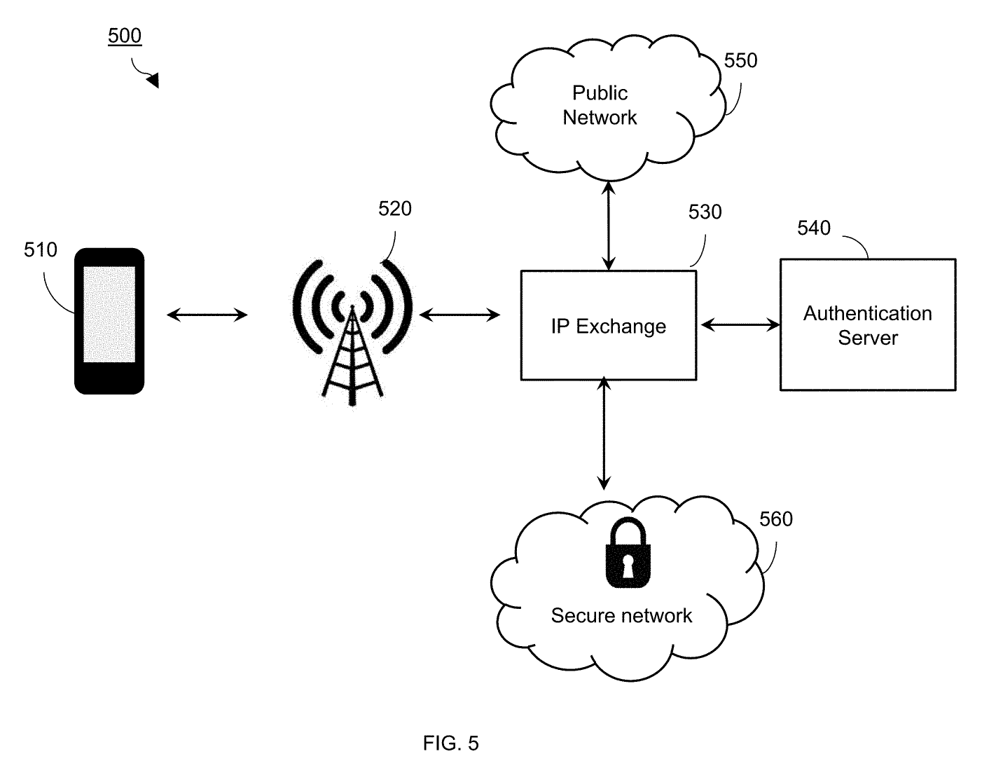

Identification/authentication technology may also be used for granting access to a secure network. For example, referring to FIG. 5, a system 500 includes a mobile device 510, a mobile network 520, an IP exchange (IPX) 530, an authentication server 540, a public network 550, and a secure network 560. Mobile device 510 is in communication with the mobile network 520. IP exchange 530 is in communication with mobile network 520, authentication server 540, public network 550, and secure network 560.

In general, mobile network 520 is a provider of connectivity between mobile device 510 and IP exchange 530. In some implementations, mobile network 520 is a Mobile Network Operator (MNO). In some implementations, mobile network 520 is a Mobile Virtual Network Operator (MVNO) that may operate through the infrastructures provided by the MNO.

In a conventional system, the secure network 560 is typically interfaced to the internet, an example of public network 550, and access to secure network 560 is provided through a public, unsecured network. For example, an encrypted communication channel to the secure network 560 may be established over the public network, or a secure tunnel, such as a virtual private network, may be established through the public network to gain access to the private network.

In contrast, IP exchange 530 is separated from the public internet, both logically and physically, and thus not addressable nor visible from the internet (e.g., public network 550). The IP exchange 530 provides exchange of IP based traffic between various network entities such as mobile network 520, fixed operators, as well as other types of service provider such as Internet Service Providers (ISP) via an IP based Network-to-Network Interface. By communicating through IP exchange 530, a private and secure communication channel can be established directly between mobile device 510 and secure network 560 without going through the internet.

Using mobile device 510, a user can gain access to the secure network 560. For example, a combination of the identity of mobile device 510 and the gathered user authentication data (e.g., keystroke data, facial image) can be used to authenticate the user of the device to secure network 560. To that end, mobile device 510 can include a Subscription Identity Module (SIM) card which can be used to authenticate identity of mobile device 510 and user 101 of the mobile device to secure network 560.

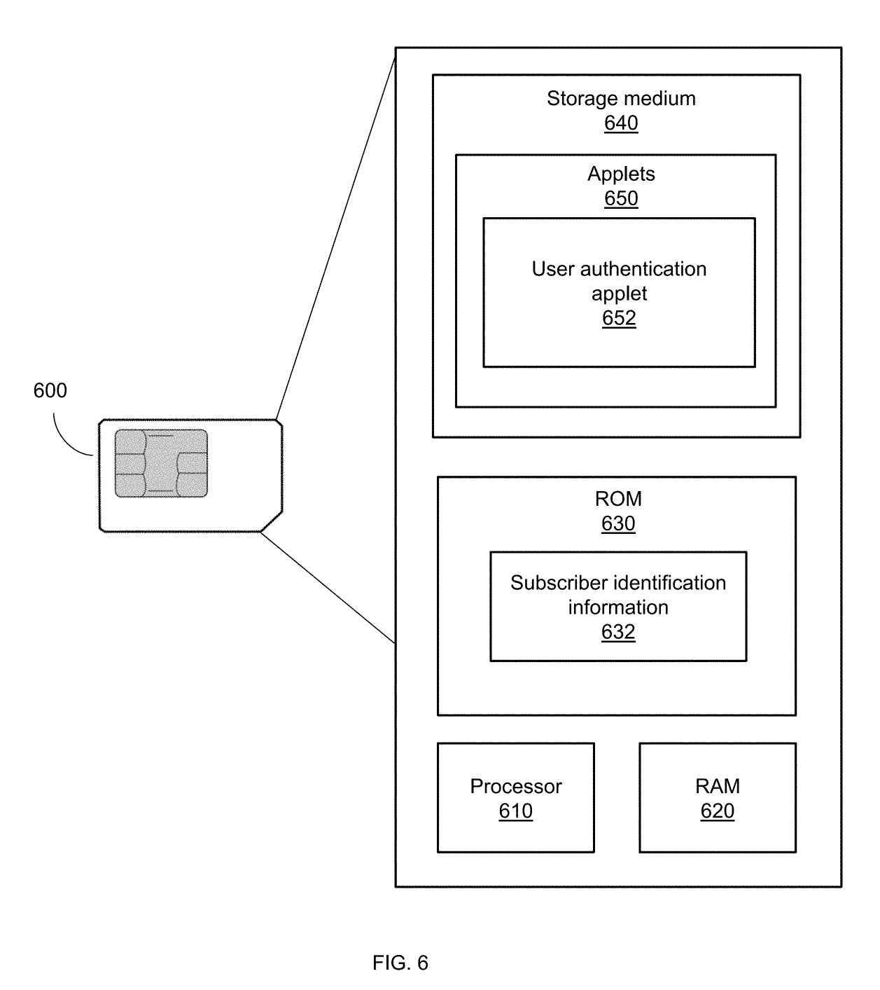

Referring to FIG. 6, a SIM card 600 includes a processor 610, a random-access memory (RAM) 620, a read-only memory (ROM) 630, and a storage medium 640. SIM card 600 is an integrated circuit capable of providing basic computing functions, and is configured to securely store subscriber identification information 632, run various types of instructions stored in storage medium 640, and provide an interface between mobile network 520 and mobile device 510.

ROM 630 can store subscriber identification information 632. Subscriber identification information 632 can include various types of information that can provide identifying information associated with mobile device 510, which can be used to identify subscribers of mobile network 520 to enable the subscribers to connect to mobile network 520. Examples of the various types of identifying information include integrated circuit card identifier (ICCID), international mobile subscriber identity (IMSI) number, and authentication key (Ki).

In some implementations, the identity of the user of a mobile device can be securely associated with subscriber identification information 632 of SIM card 600. For example, during initial access provisioning process to secure network 560, the identity of the user can be positively verified in various ways, including biometric authentication, ID verification, and review by a compliance officer. Based on such verifications, a SIM card can be issued to the user that contains user identity information associated with the SIM card's subscriber identification information. For example, the user identity information can be stored in ROM 630 of the SIM card 600 to prevent modification of the user identity information.

A traditional function of SIM card 600 is to authenticate mobile device 510 holding SIM card 600 to mobile network 520. For example, the authentication key Ki can be used in an encryption protocol between mobile device 510 and mobile network 520 to secure the communication channel between the two and authenticate the device to mobile network 520 using, for example, a cryptographic signature. However, such traditional method of authenticating mobile device 510 to mobile network 520 cannot ensure the identity of user 101 controlling the mobile device 510. A user authentication applet may be used to provide such user identity verification.

Storage medium 640 stores applets 650, including a user authentication applet 652. Applets 650 are software programs that reside on SIM card 600 and executed by processor 610 of SIM card 600. For example, in a Java card, which is an example of a SIM card, applets 640 are java applets that can be run on a java virtual machine running on processor 610. Applets 650 and can provide additional functionality to mobile device 510. Different from conventional applications residing on a storage medium of the mobile device 510, applets 650 are loaded during the initial startup of the mobile device 510, and may be able to perform tasks that conventional applications residing on mobile device 510 cannot perform.

In some implementations, the user authentication applet 652 running on SIM card 600 can interact with an operating system of mobile device 510 at a low level, gathering various authentication data for verifying a user's identity. Transparent to the user, user authentication applet 652 can encrypt and relay the authentication data along with the subscriber identification information 632 to the authentication server 540 to determine or verify the identity of the user of mobile device 510. The authentication server 540 verifies the identity of the mobile device using the subscribe identification information, and verifies the identity of the user of the mobile device using the authentication data.

In some implementations, the authentication server notifies IP exchange 530 of the successful authentication of the user of mobile device 510. Based on this information, IP exchange 530 may grant mobile device 510 access to secure network 560 by making secure network visible, or reachable, to mobile device 510. Such a scheme shields secure network 560 from various threats in public network 550, as secure network 560 is reachable only to authenticated devices. Furthermore, because the authentication provided by the authentication server is an authentication of the identity of the user of the mobile device, identity of the user can be made known to other connected devices and users of the secure network, providing attribution of actions performed by the devices on the secure network.

Examples of SIM card 600 include Universal integrated circuit card (UICC) and Java card. While SIM card 600 has been described, the functions of SIM card 600 including user authentication applet maybe provided in other form factors. Examples of other form factors include a universal subscribe identity module (USIM), removable user identity module (RUIM), integrated circuit card (ICC), and IP multimedia subsystem SIM (ISIM).

In some implementations, the contents of storage medium 640, such as applets 650 can be updated through an Over-The-Air (OTA) update process. OTA update may enable a provider of the secure network or authentication service to push out updated applets to SIM card in a secure fashion without user intervention.

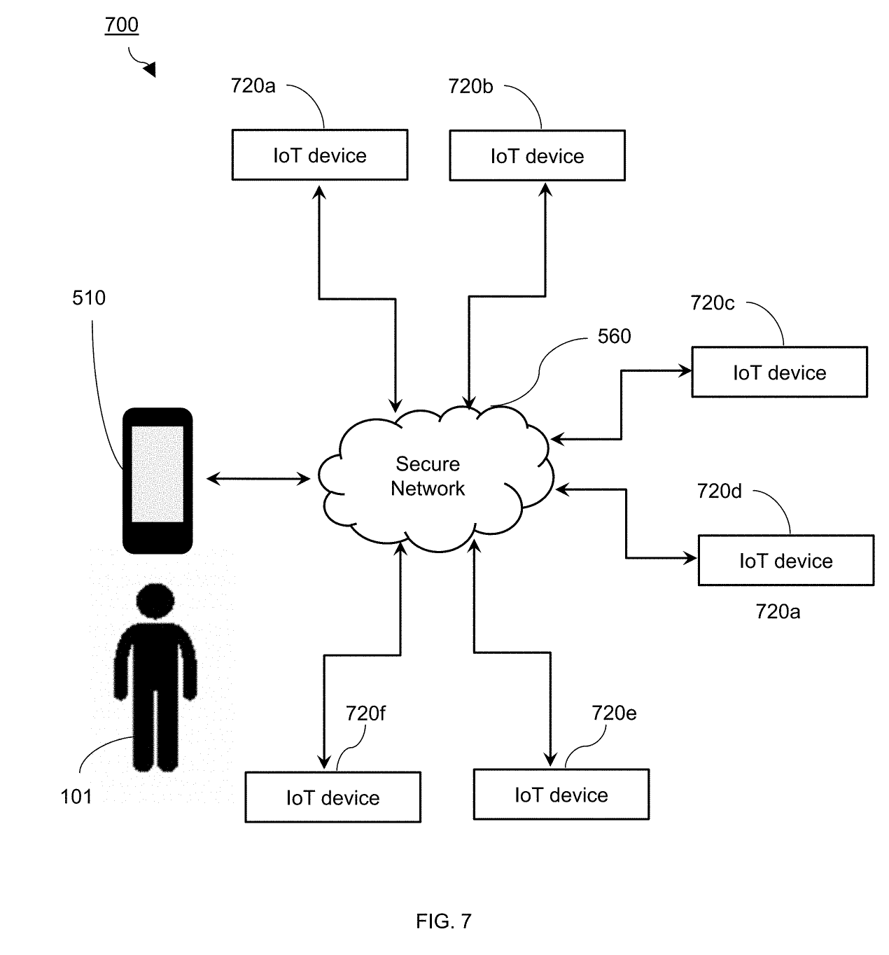

One application of secure network 560 is in securing a network of Internet-of-Things (IoT) devices. Referring to FIG. 7, a system 700 includes mobile device 510, secure network 560, and multiple IoT devices 720a through 720f Mobile device 510 and IoT devices are connected to secure network 560.

IoT devices are network-enabled devices that can perform various functions in various settings, such as home and factory. Examples of IoT devices in home setting include security cameras, security sensors, thermostats, and appliances that communicate over the network to provide various data and control. Examples of IoT devices in factories include industrial sensors, robots, machines, and controllers. Secure network 560 helps secure the data generated and communicated by the IoT devices, and prevent unauthorized access or control of the IoT devices.

In a factory setting, for example, control over the IoT devices may be granted to a foreman or a manager of a factory shift. At the end of a shift, a different foreman in charge of the next shift takes over the control of the IoT devices. The control of the IoT devices can be performed, for example, using mobile device 510. Mobile device 510, through the user authentication applet that authenticates the identity of user 101, e.g. the foreman, can seamlessly access secure network 560 to control the IoT devices 720a through 720f.

In addition to taking over the control of the IoT devices using mobile device 510, the user identity authentication provided by mobile device 510 can be used to provide attribution to, or set ownership status of, the IoT devices. For example, at the beginning of a new shift, the change of control over IoT devices 720a through 720f can be accompanied by setting the ownership of each of the IoT devices as the foreman of the shift. Attribution of actions performed by IoT devices can be important in certain situations. For example, when an IoT device causes bodily damage or property damage due to incorrect application of control commands, ownership information of the IoT devices can be used to determine the responsible party.

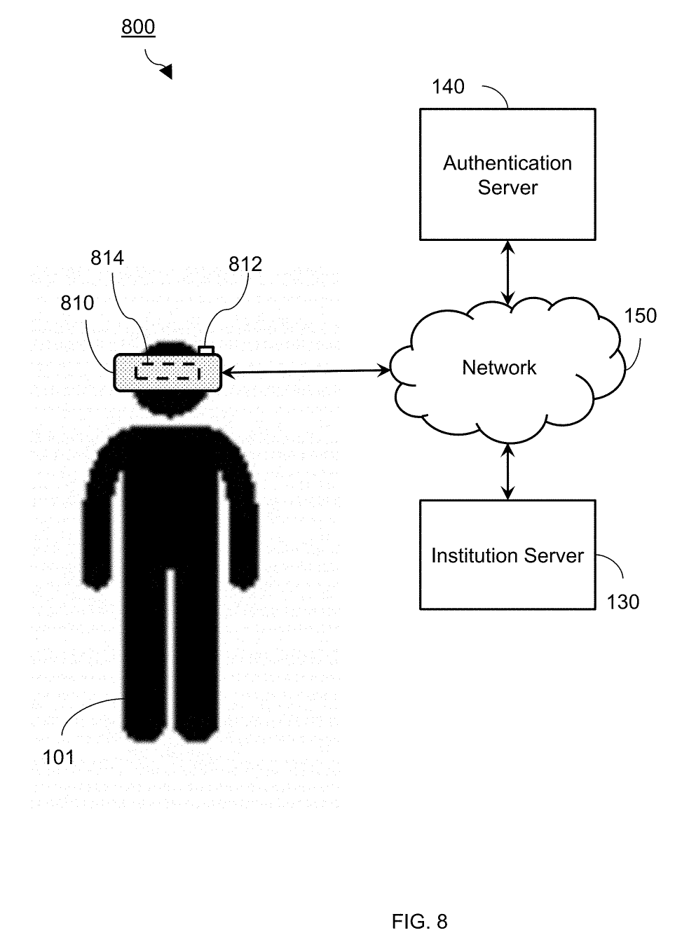

In some embodiments, the user interface can be a headset for a virtual reality or augmented reality system. For example, referring to FIG. 8, a system 800 includes a headset 810, an institution server 130, and an authentication server 140, which communicate with each other over network 150, such as the internet. Headset 810 includes a camera 812 facing the user, for capturing digital images of the user's eyes, and a display 814 for displaying images to the user. The displayed images can either immerse user 101 in a virtual environment or can augment the user's natural environment. Camera 812 provides iris detection and eye tracking capabilities with sufficient accuracy and resolution for user identification and authentication.

User 101 interacts with headset 810 by securing it to the user's head over the user's eyes. Camera 812 track and collect authentication data, such as user eye behavior, and headset 810 sends such data to authentication server 140. Authentication server 140 identifies and authenticates the user to institution server 130, which in turn grants user access to programs, e.g., online games, on headset 810.

To register the user's identity with device 810, user 101 secures headset 810 over the eyes. Camera 812 then analyzes and stores the user's eye and iris characteristics and behaviors. For example, eye and iris scanning may include detecting the response of the iris and eye to changes in lighting or hue or requesting the user to track a dot around display 814 to allow the photosensors of camera 812 to capture a full scan of the eye. In enclosed systems like virtual reality headsets 810, the brightness and hue of the display can be used to provide a consistent sampling environment to get accurate readings on color values of the eye and iris, which may help provide higher level of accuracy during identification.

Behavior sampling may involve requesting the user to track a dot around display 814 while analyzing and recording user's behavioral eye patterns. It may also include analyzing the shape of the eye as it reacts to one or more different combinations of hue/brightness. In addition, behavior around blinking may be tracked. For instance, the shape of the eye as it opens and closes during a blink can be tracked using edge detection. The user's response time to blinking requests may also be collected. These types of eye and iris characteristics and behavior patterns may be used as identification and authentication data by server 140.

In some implementations, authentication is continuous after user is granted access to the institution server 130. For example, headset 810 may continuously send behavioral data to authentication server 140, terminating the user's access if user's eyes are no longer observed by camera 812 or the eye characteristics do not match data collected during registration of the device. After access termination, headset 810 remains locked until user puts on the device and re-authenticates through server 140. Continuous authentication makes sensor spoofing unlikely because of this liveness requirement.

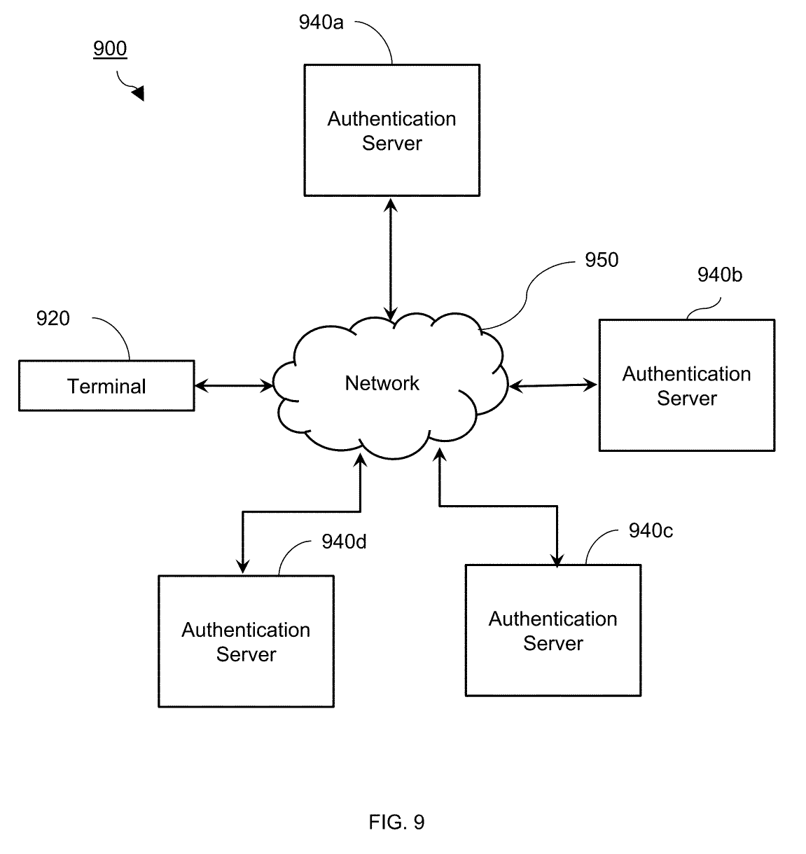

Generally, authentication servers, such as authentication server 140 and 540, performs a critical role in providing authentication decisions. Availability and integrity of the authentication decision provided by the authentication servers are critical in providing secure and high-availability secure networks and services. Referring to FIG. 9, a system 900 includes a terminal 920, multiple authentication servers 940a through 940d, and a network 950. The multiple authentication servers can provide redundancy to increase availability of the authentication service in the event that one or more authentication servers are not available due to, for example, power outage, hardware failure, network failure, or denial of service attacks.

In some implementations, the individual authentication decisions of the respective authentication servers 940a through 940d are analyzed to make a final authentication decision. During normal operations, the authentication servers provide matching authentication decisions, as the authentication servers' algorithms have been trained on a same set of training data. However, for example, in a situation when one or more of the authentication servers are breached by a malicious party, the breached authentication servers may provide incorrect authentication decisions. Various reconciliation schemes can be used to mitigate incorrect authentication decisions issued by the breached servers. For example, the final authentication decision can be based on agreement of all authentication servers. As another example, the authentication decision can be based on a majority of the authentication decisions. In addition, system administrators can be notified of the disagreement in authentication decisions to investigate and rectify the situation.

While four authentication servers are shown, the number of authentication servers can be determined based on, for example, desired availability level, or threat level. Generally, three or more authentication servers can be used.

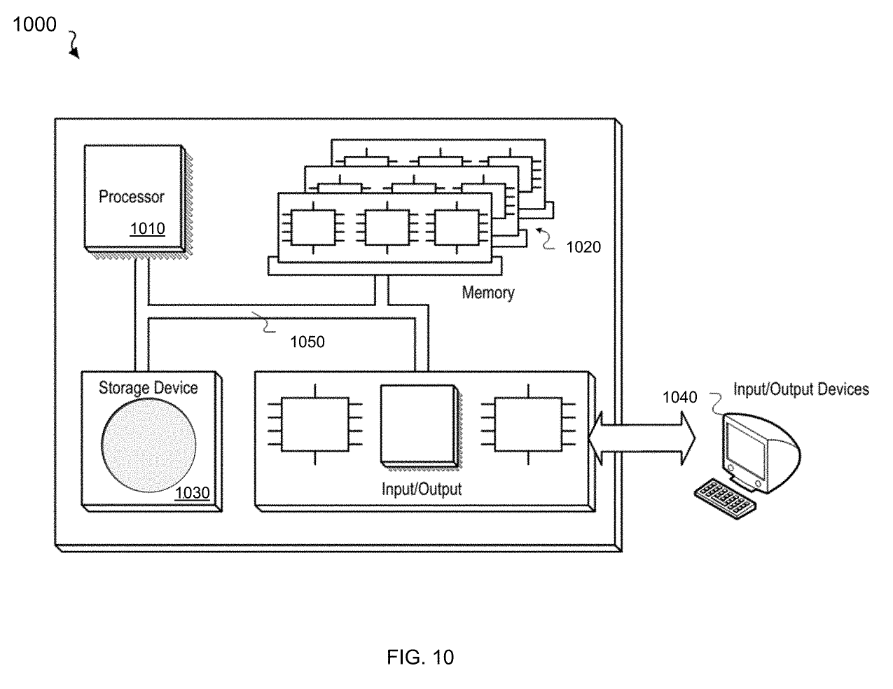

FIG. 10 is a schematic diagram of an example computer system 1000. The system 1000 can be used to carry out the operations described in association the implementations described previously. In some implementations, computing systems and devices and the functional operations described above can be implemented in digital electronic circuitry, in tangibly-embodied computer software or firmware, in computer hardware, including the structures disclosed in this specification (e.g., system 1000) and their structural equivalents, or in combinations of one or more of them. The system 1000 is intended to include various forms of digital computers, such as laptops, desktops, workstations, personal digital assistants, servers, blade servers, mainframes, and other appropriate computers, including vehicles installed on base units or pod units of modular vehicles. The system 1000 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the system 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
obtaining identification data indicative of a subject's identity;
identifying the subject using a computer system based on the identification data;
obtaining, using one or more sensors, a plurality of authentication data each separately indicative of the subject's identity, at least one of the authentication data being obtained passively;
individually analyzing each one of the plurality of authentication data using the computer system; and
validating or denying the subject's identity, using the computer system, based on the analysis of the authentication data.

2. The method of claim 1, wherein analyzing the user's identity comprises scoring each of the authentication data to provide a score, each score being indicative of a level of confidence of the subject's identity based on the corresponding authentication data.

3. The method of claim 2, wherein the scoring comprises using a corresponding predictive computer model to analyze authentication data.

4. The method of claim 3, wherein the authentication data comprises information about one or more attributes of the subject that are input into the predictive computer model.

5. The method of claim 3, wherein the predictive computer model comprises an algorithm selected from the group consisting of: an artificial neural network algorithms, a regression algorithm, an instance-based algorithm, a decision tree algorithms, a Bayesian algorithms , a clustering algorithm, a deep learning model, and an ensemble algorithms.

6. The method of claim 2, wherein validating or denying the subject's identity comprises calculating a combined score based on the score for each of the authentication data.

7. The method of claim 6, wherein calculating the combined score comprises weighting each of the scores based on information about a quality of the corresponding authentication data.

8. The method of claim 7, wherein the scores are weighted based on static weights for one or more of the authentication data.

9. The method of claim 7, wherein the scores are weighted based on dynamic weights for one or more of the authentication data.

10. The method of claim 7, wherein the information about the quality of the corresponding authentication data is obtained with the authentication data.

11. The method of claim 1, wherein the identification data is obtained actively.

12. The method of claim 1, wherein the identification data is obtained via interaction of the subject with a user interface.

13. The method of claim 12, wherein the user interface is a mobile device.

14. The method of claim 12, wherein the user interface is an automated telling machine (ATM).

15. The method of claim 12, wherein the user interface is a personal computer.

16. The method of claim 1, wherein the identification data is obtained passively.

17. The method of claim 16, wherein the identification data is obtained via a wireless data transfer from a mobile device.

18. The method of claim 16, wherein the identification data is obtained based on an image of the subject or an image of a possession of the subject's.

19. The method of claim 1, wherein the identification data comprises information about a vehicle associated with the subject.

20. The method of claim 1, wherein each of the authentication data comprises data for analysis by a corresponding identification module.

21. The method of claim 20, wherein the identification modules comprise at least one human identification module.

22. The method of claim 21, wherein the human identification module is selected from the group consisting of: a facial recognition module, a voice recognition module, a keystroke module, a language analysis module, a heartbeat module, a gait module, a device motion module, a driving behavior module, a fingerprint module, an iris module, a 3D facial recognition module, a foot shape/pressure module, an ear biometric module, an operator signature module, and a thermal signature module.

23. The method of claim 21, wherein the identification modules comprise at least one object identification module.

24. The method of claim 23, wherein the object identification module is selected from the group consisting of: a device fingerprint module, a network forensics module, a fixed LPR module, a cascade LPR module, an NFC module, a fixed low energy wireless module, a cascade low energy wireless module, a thermal signature module, and an audio signature module.

25. The method of claim 1, wherein analyzing the authentication data comprises accessing a physical model of the subject and comparing the authentication data to corresponding portions of the physical model.

26. The method of claim 25, wherein the physical model comprises a model selected from the group consisting of: a model of the subject's facial features, a model of the subject's physical proportions, a model of the subject's fingerprint, a model of the subject's iris, and a model of the subject's thermal signature.

27. The method of claim 1, wherein analyzing the authentication data comprises accessing a behavioral model of the subject and comparing the authentication data to corresponding portions of the behavioral model.

28. The method of claim 26, wherein the behavioral model comprises a model selected from the group consisting of: a model of the subject's keystroke attributes, a model of the subject's written language attributes, a model of the subject's spoken language attributes, a model of the subject's gait, and a model of the subject's driving attributes.

29. A system for authenticating a subject's identity, comprising:
a network access point comprising a user interface configured to receive identification data indicative of the subject's identity and to obtain a plurality of authentication data each separately indicative of the subject's identity, at least one of the authentication data being obtained passively; and
an authentication server in communication with the network access point, the authentication server being configured to receive the authentication data, individually analyze each of the authentication data, and validate or deny the subject's identity based on the analysis of the authentication data.

30. The system of claim 29, wherein the user interface comprises a keypad and the authentication data comprises data received from the keypad.

31. The system of claim 29, wherein the user interface comprises a headset.

32. The system of claim 29, wherein the network access point comprises a camera and the authentication data comprises data received from the camera.

33. The system of claim 29, wherein the network access point comprises components for wireless communication with a wireless device.

34. The system of claim 33, wherein the wireless device is a mobile phone or a smartwatch.

35. The system of claim 29, wherein the network access point is an automated telling machine (ATM).

36. The system of claim 29, wherein the network access point is a networked personal computer.

37. The system of claim 29, wherein the network access point is a wireless device.

38. The system of claim 29, wherein the network access point is a point-of-sale terminal.

39. The system of claim 29, further comprises an institution server in communication with the terminal and the authentication server, where institution server storing profile data related to a profile of the subject.

40. The system of claim 29, wherein the terminal and authentication server are in communication via a wide area network.

41. The system of claim 40, wherein the wide area network is the internet.

42. The system of claim 29, wherein the authentication server is configured to receive authentication data from one or more additional sources in addition to the network access point.

43. The system of claim 42, wherein the additional sources include a wireless data network.

44. The system of claim 29, wherein the authentication server comprises a plurality of authentication servers issuing a plurality of authentication decisions in response to receiving authentication data, wherein the plurality of authentication decision is analyzed to validate or deny the subject's identity.

45. The system of claim 29, wherein the network access point is a mobile device having a SIM card configured to process and securely communicate the plurality of authentication data to the authentication server.

46. A mobile device for authenticating a subject's identity, comprising:
a wireless communication unit configured to communicate with a mobile network;
a user interface configured to obtain authentication data indicative of the subject's identity, the authentication data being obtained passively;
a SIM card, comprising:
a read-only memory containing subscriber identification information associated with the mobile device; and
a processor configured to:
transmit, via the wireless communication unit, the authentication data and the subscriber identification information to a authentication server;
receive, from the authentication server, an authentication decision; and
based on the authentication decision, access a secure network.
